(19) United States
(12) Patent Application Publication
(10) Pub. No.: US 2026/0009772 A1
(43) Pub. Date: Jan. 8, 2026

(54) Gas Analysis System

(71) Applicants: Yoko FURIHATA, Kyoto-shi (JP); Tetsuo FURUMIYA, Kyoto-shi (JP)

(72) Inventors: Yoko FURIHATA, Kyoto-shi (JP); Tetsuo FURUMIYA, Kyoto-shi (JP)

(21) Appl. No.: 19/258,439

(22) Filed: Jul. 2, 2025

(30) Foreign Application Priority Data
Jul. 4, 2024 (JP) 2024-108100

(51) Int. Cl. G01N 30/14; B01D 53/02; B01D 53/04; B01D 53/26; G01N 30/02; G01N 30/74; G01N 31/12

(52) U.S. Cl. CPC G01N 30/14; B01D 53/025; B01D 53/0423; B01D 53/26; G01N 30/74; G01N 31/12; B01D 2253/108; B01D 2257/402; B01D 2257/504; B01D 2257/80; G01N 2030/025; G01N 2030/143

(57) ABSTRACT

A gas analysis system (1) includes a combustion device (10), a gas treatment device (20), and a CRDS gas analyzer (30). The gas treatment device (20) has a first gas separation unit (22) that separates a sample gas generated in the combustion device (10) into a first mixed gas of carbon dioxide and nitrous oxide and a remaining gas other than the first mixed gas and allows the first mixed gas to pass therethrough, a reduction unit (23) that reduces nitrous oxide in the first mixed gas to nitrogen and allows a second mixed gas containing carbon dioxide and nitrogen to pass therethrough, and a second gas separation unit (24) that separates the second mixed gas into carbon dioxide gas and a remaining gas other than carbon dioxide gas and supplies the carbon dioxide gas to the CRDS gas analyzer.

### TECHNICAL FIELD

The present disclosure relates to a gas analysis system that combusts and gasifies an organic sample and analyzes the gasified sample using cavity ring-down spectroscopy (CRDS).

### BACKGROUND ART

As one method for clarifying the elemental composition and the like in a solid or liquid organic sample, there is a method of analyzing a sample by combusting and gasifying it. When analysis is performed by such a method, the sample is analyzed by flowing through a combustion device, a gas treatment device, and a gas detection device in this order.

A sample and oxygen gas (O₂ gas) as an auxiliary combustion gas for promoting the combustion of the sample are supplied to the combustion device, and the sample is completely combusted and gasified. In the gas treatment device, the gas generated in the combustion device is converted into a state that can be measured by the gas detection device. For example, when an organic sample containing carbon (C), hydrogen (H), nitrogen (N), and sulfur(S) is combusted, a sample gas containing carbon dioxide (CO₂), water (H₂O), nitrogen oxides (NO_{X}), and sulfur oxides (SO_{X}) is generated in the combustion device. Note that nitrogen oxides (NO_{X}) include nitrous oxide (N₂O), nitric oxide (NO), and nitrogen dioxide (NO₂), and sulfur oxides (SO_{X}) include sulfur dioxide (SO₂) and sulfur trioxide (SO₃). When the O₂ gas supplied to the combustion device serves not only as an auxiliary combustion gas but also as a carrier gas, surplus O₂ gas that was not used for combustion in the combustion device is introduced into the gas treatment device in addition to CO₂, H₂O, NO_{X}, and SO_{X}.

As the gas detection device, a device that analyzes the elemental composition and the like in a gas using cavity ring-down spectroscopy (CRDS) (hereinafter also referred to as a “CRDS gas analyzer”) can be used. CRDS is a spectroscopic method for highly sensitive quantification of a target component contained in a gas by lengthening the effective optical path length for light absorption by the gas using an optical resonator (cavity) configured to include high-reflectivity mirrors.

When a CRDS gas analyzer is used as the gas detection device, isotopes of each of carbon (C), hydrogen (H), nitrogen (N), and sulfur(S) can be analyzed. For example, International Publication No. WO2018/135619 (Patent Document 1) discloses that, in order to accurately analyze carbon isotopes (¹²C, ¹³C, ¹⁴C) with a CRDS gas analyzer, the partial pressure ratio of CO₂ (carbon dioxide), which is the measurement target, is increased by passing the sample gas generated in the combustion device through a gas treatment device, and the gas with a high partial pressure ratio of CO₂ is supplied to the CRDS gas analyzer.

Further, for example, International Publication No. WO2020/105715 (Patent Document 2) or Japanese Patent Publication No. Sho 61-33468 (Patent Document 3) describes reducing oxides contained in a sample gas generated in a combustion device in a reduction unit filled with reduced copper in an apparatus for analyzing organic elements.

### PRIOR ART DOCUMENTS

### Patent Documents

Patent Document 1: International Publication No. WO2018/135619
Patent Document 2: International Publication No. WO2020/105715
Patent Document 3: Japanese Patent Publication No. Sho 61-33468

### SUMMARY OF THE INVENTION

### Problem to be Solved by the Invention

As a configuration for increasing the partial pressure ratio of CO₂, which is the measurement target, in the gas treatment device, it is conceivable that the gas treatment device includes a gas separation unit that separates CO₂ gas and other gases by temporarily trapping the CO₂ gas contained in the gas generated in the combustion device and exhausting the other gases to the outside.

However, in reality, it is difficult to separate CO₂ gas and N2O (nitrous oxide) gas with only one gas separation unit. That is, conventionally, it has been difficult to realize a gas separation unit that traps CO₂ without trapping N2O, and in reality, it is assumed that not only CO₂ but also N2O is trapped in the gas separation unit, and as a result, not only CO₂ but also N2O is introduced into the CRDS gas analyzer. If CO₂ and N2O are introduced into the CRDS gas analyzer, a problem may arise in that the quantitative accuracy of ¹⁴CO₂ deteriorates due to interference of spectral peaks because an absorption line of N2O exists near the absorption line of ¹⁴CO₂.

As a countermeasure to this problem, it is conceivable to provide a reduction unit upstream of the gas separation unit. The reduction unit is configured by maintaining a reduction tube filled with reduced copper at a high temperature (for example, about 600 to 850° C.), and plays three roles: a role of reducing NO_{X} including N₂O to N₂, a role of reducing SO₃ to SO₂, and a role of removing surplus O₂.

However, if the above-mentioned reduction unit is simply provided upstream of the gas separation unit, a new problem may arise in that the maintenance frequency of the reduction unit becomes very high. As described above, the reduction unit plays three roles (a role of reducing nitrogen oxides, a role of reducing sulfur oxides, and a role of removing surplus O₂), but the reduced copper in the reduction unit is oxidized and changed to copper oxide by these chemical reactions, so it is necessary to periodically replace or regenerate the reduced copper. In particular, when the O₂ gas supplied to the combustion device plays both the roles of an auxiliary combustion gas and a carrier gas, a large amount of surplus O₂ is introduced into the reduction unit. Therefore, for example, if a reduction tube is filled with 100 g of reduced copper and 900 mL of O₂ gas is introduced into the reduction tube in one analysis, it is necessary to replace or regenerate the reduced copper at a frequency of approximately once every two analyses, and the maintenance frequency of the reduction unit becomes very high.

The present disclosure has been made to solve such problems, and its object is to enable accurate analysis of carbon isotopes while suppressing the maintenance frequency of a reduction unit in a gas analysis system including a gas treatment device in which the reduction unit is arranged upstream of a gas separation unit.

### Means for Solving the Problem

A gas analysis system according to the present disclosure includes a combustion device that generates a sample gas by combusting a sample with oxygen introduced therein, a gas treatment device that increases a partial pressure ratio of carbon dioxide gas in the sample gas, and a CRDS gas analyzer that analyzes the carbon dioxide gas that has passed through the gas treatment device using cavity ring-down spectroscopy. The gas treatment device has a first gas separation unit that separates the sample gas into a first mixed gas of carbon dioxide gas and nitrous oxide gas and a remaining gas other than the first mixed gas and allows the first mixed gas to pass therethrough, and a reduction unit that is arranged downstream of the first gas separation unit and reduces nitrous oxide gas in the first mixed gas to nitrogen gas to allow a second mixed gas containing carbon dioxide gas and nitrogen gas to pass therethrough.

### Effects of the Invention

According to the present disclosure, in a gas analysis system including a gas treatment device in which a reduction unit is arranged upstream of a gas separation unit, it is possible to accurately analyze carbon isotopes while suppressing the maintenance frequency of the reduction unit.

### BRIEF DESCRIPTION OF THE DRAWINGS

FIG. 1 is a diagram schematically showing an example of the overall configuration of a gas analysis system (Part 1).

FIG. 2 is a diagram showing the flow of gas in a first step of gas treatment by a gas treatment device.

FIG. 3 is a diagram showing the flow of gas in a second step of gas treatment by the gas treatment device.

FIG. 4 is a diagram showing the flow of gas in a third step of gas treatment by the gas treatment device.

FIG. 5 is a diagram schematically showing an example of the configuration of a general organic elemental analyzer using a GC column.

FIG. 6 is a diagram schematically showing an example of the overall configuration of a gas analysis system (Part 2).

### DESCRIPTION OF EMBODIMENTS

Hereinafter, embodiments of the present invention will be described in detail with reference to the drawings. In the following, the same or corresponding parts in the drawings are denoted by the same reference numerals, and description thereof will not be repeated.

### <Overall Configuration of Gas Analysis System 1>

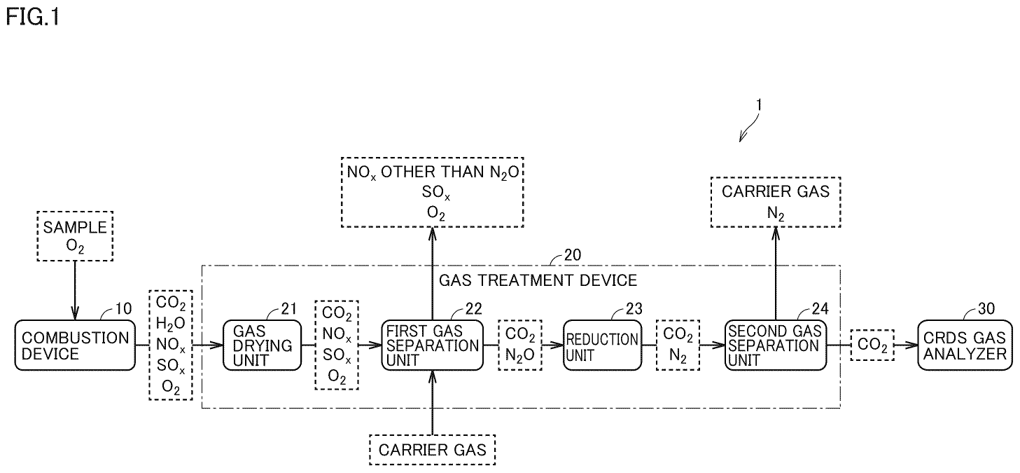

FIG. 1 is a diagram schematically showing an example of the overall configuration of a gas analysis system 1 according to the present embodiment. The gas analysis system 1 can combust and gasify an organic sample and analyze the composition ratio of carbon isotopes in the sample from CO₂ contained in the gasified sample.

The gas analysis system 1 includes a combustion device 10, a gas treatment device 20, and a CRDS gas analyzer 30.

An organic sample and O₂ gas are supplied to the combustion device 10 from the outside. The O₂ gas supplied to the combustion device 10 serves as an auxiliary combustion gas for promoting the combustion of the sample and as a carrier gas for transporting the sample gas after combustion to a subsequent stage. The combustion device 10 completely combusts the organic sample to generate a sample gas. The sample gas generated in the combustion device 10 includes carbon dioxide (CO₂), water (H₂O), nitrogen oxides (NO_{X}), sulfur oxides (SO_{X}), and surplus oxygen gas (O₂) that was not used for combustion.

The gas treatment device 20 converts the sample gas generated in the combustion device 10 into a state in which CO₂ can be analyzed by the CRDS gas analyzer 30, and supplies the converted gas to the CRDS gas analyzer 30. The configuration of the gas treatment device 20 will be described in detail later.

The CRDS gas analyzer 30 quantifies carbon isotopes in the sample using CRDS from the gas supplied from the gas treatment device 20. As described above, CRDS is a spectroscopic method for highly sensitive quantification of a target component contained in a gas by lengthening the effective optical path length for light absorption by the gas using an optical resonator (cavity) configured to include high-reflectivity mirrors.

Radiocarbon isotope ¹⁴C, one of the carbon isotopes, is the only long-lived radioisotope among the isotopes of elements and is used as an environmental tracer. For example, by measuring the abundance ratio of ¹⁴C in an organic resource, it can be determined whether the organic resource is derived from biomass from plants or from fossil fuels. ¹⁴C is also used as a biological tracer. In drug development, by administering a compound in which a part of the carbon of the compound is labeled with ¹⁴C to a living body and measuring the concentration of ¹⁴C accumulated in its blood, urine, feces, and organs, the pharmacokinetics of the administered compound can be analyzed. However, since the isotopic ratio of ¹⁴C is very low, it is necessary to distinguish ¹⁴C from other carbon isotopes ¹²C and ¹³C and detect ¹⁴C with high sensitivity in order to measure ¹⁴C. In CRDS, since the sensitivity is improved by lengthening the effective optical path length for light absorption by the gas using an optical resonator, ¹⁴C can be detected with high sensitivity.

### <Configuration of Gas Treatment Device 20>

The gas treatment device 20 includes a gas drying unit 21, a first gas separation unit 22, a reduction unit 23, and a second gas separation unit 24. The gas drying unit 21, the first gas separation unit 22, the reduction unit 23, and the second gas separation unit 24 are arranged in this order between the combustion device 10 and the CRDS gas analyzer 30.

The gas drying unit 21 is arranged between the combustion device 10 and the first gas separation unit 22 and removes H2O (water component) in the sample gas generated in the combustion device 10. If H2O is introduced into the CRDS gas analyzer 30, the accuracy of CRDS measurement deteriorates because H2O adheres to the high-reflectivity mirrors in the CRDS gas analyzer 30, thereby reducing the reflectivity of the mirrors. However, in the gas treatment device 20 according to the present embodiment, H2O in the sample gas generated in the combustion device 10 is removed by the gas drying unit 21. Therefore, it is possible to avoid a decrease in the accuracy of CRDS measurement due to H2O adhering to the high-reflectivity mirrors in the CRDS gas analyzer 30. Since H2O does not change even when passing through the reduction unit 23, the gas drying unit 21 is not limited to being arranged upstream of the reduction unit 23, and may be arranged downstream of the reduction unit 23 (for example, between the reduction unit 23 and the second gas separation unit 24).

The first gas separation unit 22 is arranged upstream of the reduction unit 23 (specifically, between the gas drying unit 21 and the reduction unit 23) and separates the sample gas that has passed through the gas drying unit 21 into a first mixed gas of CO₂ and N2O and a remaining gas other than the first mixed gas, and allows the first mixed gas to pass therethrough. The remaining gas other than the first mixed gas is exhausted to the outside. The remaining gas other than the first mixed gas includes NOX other than N2O, SOX, and O₂. That is, the first gas separation unit 22 has a function of removing surplus oxygen gas (O₂) that was not used for combustion in the combustion device 10.

The first gas separation unit 22 according to the present embodiment is configured to temporarily trap the first mixed gas, exhaust the remaining gas other than the first mixed gas to the outside while the first mixed gas is temporarily trapped, and supply the first mixed gas to the reduction unit 23 after exhausting the remaining gas other than the first mixed gas to the outside.

For example, the first gas separation unit 22 can be configured by an adsorption column filled with an adsorbent that adsorbs CO₂ and N2O. As the adsorption column constituting the first gas separation unit 22, adsorption columns of types such as zeolite 13X, zeolite 5A, and zeolite 4A can be used. Regardless of which adsorption column is used, it is practically difficult to trap only CO₂ without trapping N2O in the first gas separation unit 22, and in reality, CO₂ and N2O are trapped in the first gas separation unit 22.

The first gas separation unit 22 is not necessarily limited to being configured by an adsorption column. For example, the first gas separation unit 22 may be configured to temporarily trap CO₂ by locally cooling a part of a gas flow path using refrigerator to temporarily solidify CO2. However, even in this case, since the freezing points of CO2 and N2O are close, it is practically difficult to trap only CO₂ without trapping N2O in the first gas separation unit 22, as in the case of an adsorption column, and in reality, CO₂ and N2O are trapped in the first gas separation unit 22.

A carrier gas having a composition different from that of O₂ (for example, helium He or argon Ar) is supplied to the first gas separation unit 22 from the outside. As a result, even when O₂ gas, which also functions as a carrier gas, is removed by the first gas separation unit 22, the first mixed gas can be transported to the reduction unit 23 by a carrier gas having a composition different from that of O₂ gas.

The reduction unit 23 reduces N2O in the first mixed gas that has passed through the first gas separation unit 22 to N2, and allows a second mixed gas containing CO₂ and N2 to pass therethrough.

The reduction unit 23 is configured by maintaining a reduction tube filled with reduced copper at a high temperature (for example, about 600 to 850° C.) and plays a role of reducing NOX including N2O to N2. When a small amount of SO3 and O₂ that could not be removed by the first gas separation unit 22 is contained in the first mixed gas, the reduction unit 23 also plays a role of reducing SO3 to SO₂ and a role of removing O₂.

The second gas separation unit 24 separates the second mixed gas that has passed through the reduction unit 23 into CO₂ gas and a remaining gas other than CO₂, and supplies the CO₂ gas to the CRDS gas analyzer 30. The remaining gas other than CO₂ is exhausted to the outside. The remaining gas other than CO₂ includes a carrier gas and N2.

The second gas separation unit 24 according to the present embodiment can have the same configuration as the first gas separation unit 22. That is, for example, the second gas separation unit 24 can be configured by an adsorption column filled with an adsorbent that adsorbs CO₂. As the adsorption column of the second gas separation unit 24, a column such as zeolite 13X, zeolite 5A, or zeolite 4A can be used, as in the first gas separation unit 22. However, regardless of which adsorption column is used, as described above, it is difficult to configure the second gas separation unit 24 to trap only CO₂ without trapping N2O, and in reality, not only CO₂ but also N2O is trapped in the second gas separation unit 24.

However, in the gas treatment device 20 according to the present embodiment, a reduction unit 23 that reduces N2O to N2 is arranged upstream of the second gas separation unit 24. Therefore, it is possible to prevent N2O from being present in the second mixed gas supplied to the second gas separation unit 24 in the first place. As a result, only CO₂ is trapped in the second gas separation unit 24, so that the gas introduced into the CRDS gas analyzer 30 through the second gas separation unit 24 does not contain N2O and contains only CO₂. As a result, interference between the spectral peaks of CO₂ and N2O in the CRDS gas analyzer 30 can be avoided, and carbon isotopes can be quantified with high accuracy.

Furthermore, in the gas treatment device 20 according to the present embodiment, the first gas separation unit 22 is arranged upstream of the reduction unit 23. This can suppress the maintenance frequency of the reduction unit 23.

That is, assuming that the first gas separation unit 22 is not arranged upstream of the reduction unit 23, the reduction unit 23 would play three roles: reducing NOX including N2O to N2, reducing SO3 to SO₂, and removing surplus O₂. Since the reduced copper in the reduction unit 23 is oxidized to copper oxide by these chemical reactions, it is necessary to periodically replace or regenerate the reduced copper in the reduction unit 23. In particular, in the present embodiment, since the O₂ supplied to the combustion device 10 serves as a carrier gas, if there is no first gas separation unit 22 upstream of the reduction unit 23, a large amount of surplus O₂ is introduced into the reduction unit 23, which causes a problem that the maintenance frequency of the reduction unit 23 becomes very high. For example, if the reduction unit 23 is filled with 100 g of copper and 900 mL of O₂ gas is introduced into the reduction unit 23 in one analysis, it is necessary to replace or regenerate the reduced copper in the reduction unit 23 once every two analyses, which is not realistic as a maintenance frequency.

However, in the gas treatment device 20 according to the present embodiment, surplus O₂ is removed by the first gas separation unit 22 arranged upstream of the reduction unit 23. Therefore, a large amount of surplus O₂ is prevented from being supplied to the reduction unit 23. As a result, the maintenance frequency of the reduction unit 23 can be kept low.

### <Switching of Gas Flow Path of Gas Treatment Device 20>

In the gas treatment by the gas treatment device 20 according to the present embodiment, the gas flow path is switched by a valve operation (not shown) in the order of a first step, a second step, and a third step.

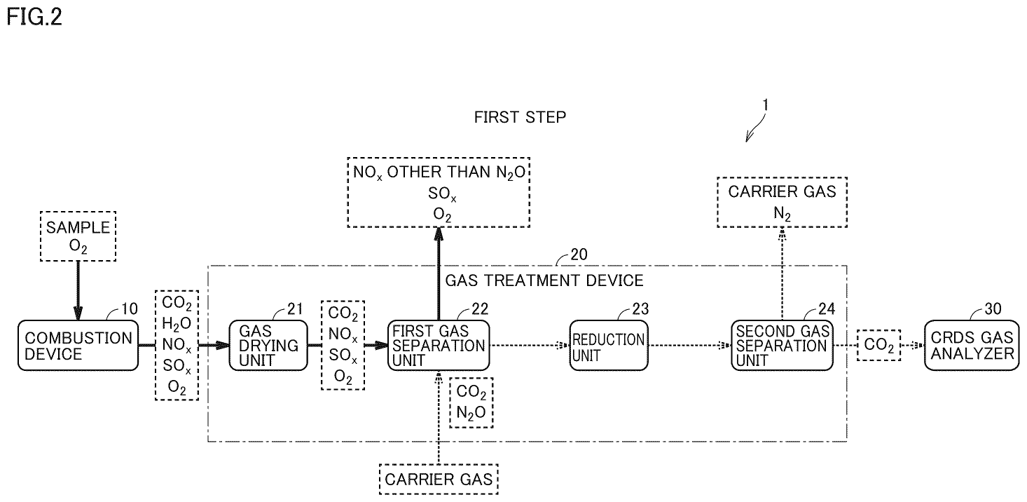

FIG. 2 is a diagram showing the flow of gas in a first step of gas treatment by the gas treatment device 20. In the first step, with the first gas separation unit 22 in a low-temperature state (a state of trapping the first mixed gas), the sample gas flows through the gas drying unit 21 and the first gas separation unit 22 and is exhausted from the first gas separation unit 22 to the outside. As a result, the first mixed gas (CO₂, N2O) is trapped in the first gas separation unit 22, and the remaining gas other than the first mixed gas (NOX other than N2O, SOX, O₂) is exhausted to the outside.

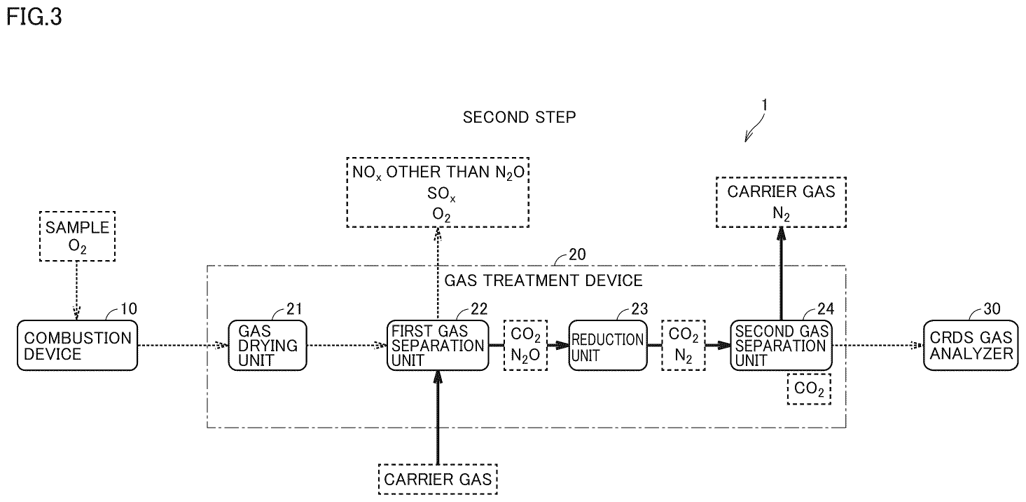

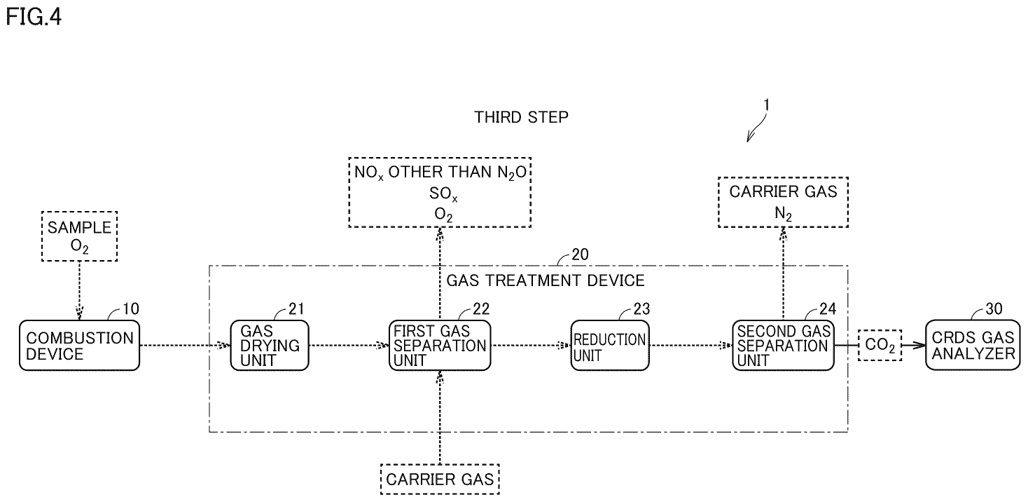

FIG. 3 is a diagram showing the flow of gas in a second step of gas treatment by the gas treatment device 20. In the second step, with the first gas separation unit 22 in a high-temperature state (a state of releasing the first mixed gas) and the second gas separation unit 24 in a low-temperature state (a state of trapping the second mixed gas), a carrier gas different from O₂ is supplied to the first gas separation unit 22, whereby the first mixed gas (CO₂, N2O) trapped in the first gas separation unit 22 is released, flows through the reduction unit 23 and the second gas separation unit 24, and is exhausted from the second gas separation unit 24 to the outside. As a result, the first mixed gas (CO₂, N2O) is converted into a second mixed gas (CO₂, N2) in the reduction unit 23 and supplied to the second gas separation unit 24. In the second gas separation unit 24, CO₂ in the second mixed gas is trapped, and the remaining gas other than CO₂ is exhausted to the outside. FIG. 4 is a diagram showing the flow of gas in a third step of gas treatment by the gas treatment device 20. As shown in FIG. 4, in the third step, the second gas separation unit 24 is brought to a high temperature, whereby the CO₂ trapped in the second gas separation unit 24 is released and supplied to the CRDS gas analyzer 30. By such gas treatment of the gas treatment device 20, a gas with a high partial pressure ratio of CO₂ can be supplied to the CRDS gas analyzer 30.

As described above, in the gas analysis system 1 according to the present embodiment, the sample gas generated by combusting an organic sample in the combustion device 10 passes through the first gas separation unit 22, the reduction unit 23, and the second gas separation unit 24 in this order and is supplied to the CRDS gas analyzer 30.

In the first gas separation unit 22, gases other than the first mixed gas (CO₂, N2O) are removed, and the first mixed gas is supplied to the reduction unit 23. That is, NOX other than N2O, SOX, and surplus O₂ gas are removed by the first gas separation unit 22 arranged upstream of the reduction unit 23. This reduces the amount of oxygen reduced by the reduced copper in the reduction unit 23, so that the maintenance frequency of the reduction unit 23 can be kept low.

In the reduction unit 23, N2O contained in the first mixed gas is reduced to N2, and a second mixed gas containing CO₂ and N2 is supplied to the second gas separation unit 24. This allows a second mixed gas not containing N2O to be supplied to the second gas separation unit 24.

In the second gas separation unit 24, gases other than CO₂ are removed from the second mixed gas, and CO₂ is supplied to the CRDS gas analyzer 30. As described above, the second mixed gas introduced into the second gas separation unit 24 is in a state of not containing N2O due to the reduction action of the reduction unit 23. Therefore, even if the second gas separation unit 24 has a configuration that cannot separate CO₂ and N2O, N2O is not introduced into the CRDS gas analyzer 30, but CO₂ is introduced. As a result, interference between the spectral peaks of CO₂ and N2O in the CRDS gas analyzer 30 can be avoided, and carbon isotopes can be quantified with high accuracy.

As a result of the above, the gas analysis system 1 according to the present disclosure can accurately analyze carbon isotopes while suppressing the maintenance frequency of the reduction unit 23.

### <Modification 1>

By using a solid combustion device of a TOC (Total Organic Carbon) analyzer as the combustion device 10 in the above-described embodiment, the solid combustion device of the TOC analyzer may be combined with the gas treatment device 20 and the CRDS gas analyzer 30 in the above-described embodiment.

When a sample containing carbon, hydrogen, nitrogen, and sulfur is combusted in a solid combustion device of a TOC analyzer, CO₂, NOX, SOX, and O₂ are exhausted from the solid combustion device of the TOC analyzer. Therefore, the solid combustion device of a TOC analyzer may be used as the combustion device 10 in the above-described embodiment.

### <Modification 2>

By using a combustion unit of a general organic elemental analyzer using a gas chromatography (GC) column as the combustion device 10 in the above-described embodiment, the general organic elemental analyzer using a GC column may be combined with the gas treatment device 20 and the CRDS gas analyzer 30 in the above-described embodiment.

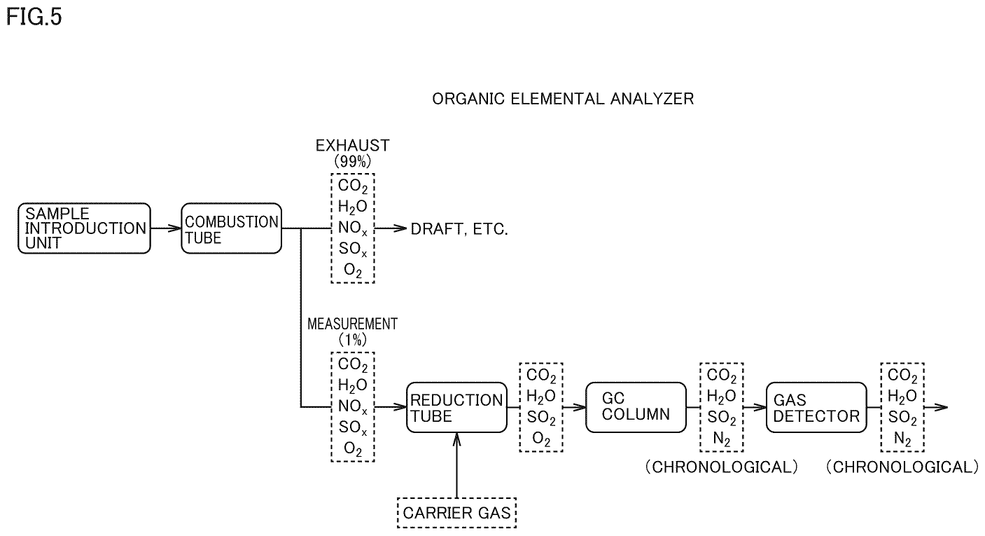

FIG. 5 is a diagram schematically showing an example of the configuration of a general organic elemental analyzer using a GC column. A general organic elemental analyzer using a GC column performs organic elemental analysis by introducing a part of the gas sampled from the combustion gas generated in a combustion tube into a reduction tube, a GC column, and a gas detector. Although the capacity of a general GC column is a very small value (for example, about several μL), the maximum sample amount combusted in an organic elemental analyzer is a very large value compared to the capacity of the GC column (for example, about 2 g for a solid and about 5 mL for a liquid), so the amount of gas generated in the combustion tube greatly exceeds the capacity of the GC column. Therefore, it is configured such that only a small amount (for example, 1%) of the gas generated in the combustion tube is used for measurement, and the majority (for example, 99%) is exhausted to the outside.

In the CRDS gas analyzer 30, if the pressure inside the cavity is low, the spectral intensity becomes low and the SN (Signal to Noise) ratio deteriorates, so it is necessary to maintain the pressure inside the cavity at a certain level or higher. Therefore, when an organic elemental analyzer as shown in FIG. 5 is used as the combustion device 10, it is more advantageous for pressure improvement to introduce a large amount of mixed gas that is exhausted into the CRDS gas analyzer 30 than to measure a small amount of combustion gas sampled for measurement.

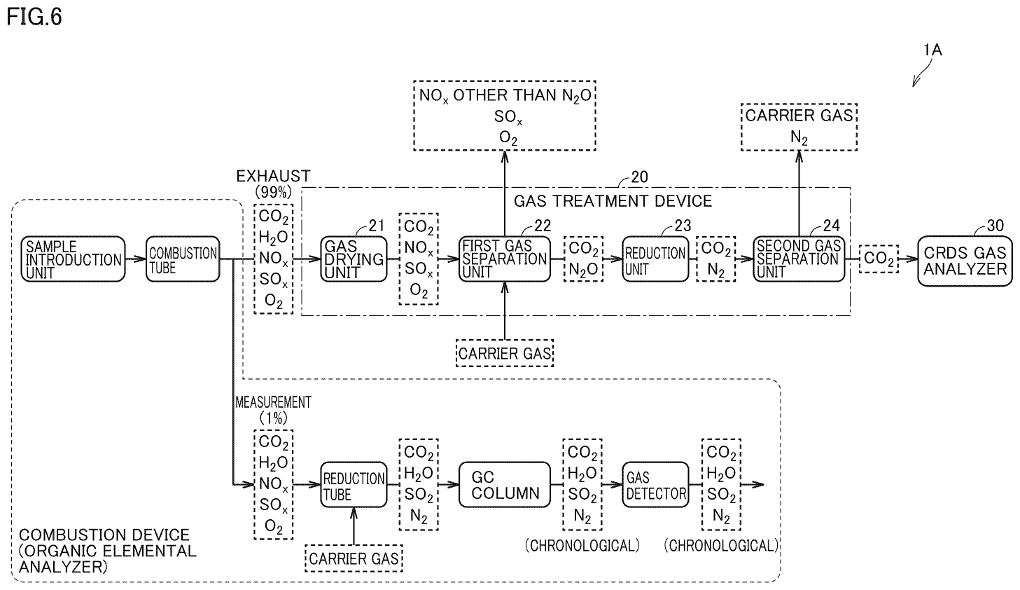

FIG. 6 is a diagram schematically showing an example of the overall configuration of a gas analysis system 1A in which an organic elemental analyzer using a GC column is combined with the gas treatment device 20 and the CRDS gas analyzer 30 in the above-described embodiment. In the gas analysis system 1A, as shown in FIG. 6, a large amount of mixed gas exhausted from a combustion tube of an organic elemental analyzer using a GC column is introduced into the gas treatment device 20. This allows the mixed gas that is exhausted without being used for measurement in the organic elemental analyzer using a GC column to be effectively used as a sample gas for CRDS.

### [Aspects]

It will be understood by those skilled in the art that the above-described embodiments and modifications thereof are specific examples of the following aspects.

(Item 1) A gas analysis system according to the present disclosure includes a combustion device that generates a sample gas by combusting a sample with oxygen introduced therein, a gas treatment device that increases a partial pressure ratio of carbon dioxide in the sample gas, and a CRDS gas analyzer that analyzes the carbon dioxide gas that has passed through the gas treatment device using cavity ring-down spectroscopy. The gas treatment device has a first gas separation unit that separates the sample gas into a first mixed gas of carbon dioxide and nitrous oxide and a remaining gas other than the first mixed gas and allows the first mixed gas to pass therethrough, and a reduction unit that is arranged downstream of the first gas separation unit and reduces nitrous oxide in the first mixed gas to nitrogen to allow a second mixed gas containing carbon dioxide and nitrogen to pass therethrough.

In the gas analysis system according to item 1, the sample gas generated by combusting an organic sample in a combustion device passes through a first gas separation unit and a reduction unit in this order and is supplied to a CRDS gas analyzer.

In the first gas separation unit, gases other than the first mixed gas (carbon dioxide and nitrous oxide) are removed, and the first mixed gas is supplied to the reduction unit. That is, oxygen gas (remaining gas other than the first mixed gas) is removed by the first gas separation unit arranged upstream of the reduction unit. This reduces the amount of oxygen reduced in the reduction unit, so that the maintenance frequency of the reduction unit can be kept low.

In the reduction unit, nitrous oxide contained in the first mixed gas is reduced to nitrogen, and a second mixed gas containing carbon dioxide and nitrogen is supplied to the CRDS gas analyzer. This allows a second mixed gas not containing nitrous oxide to be supplied to the CRDS gas analyzer.

Therefore, carbon dioxide is introduced into the CRDS gas analyzer without nitrous oxide being introduced. As a result, interference between the spectral peaks of carbon dioxide and nitrous oxide in the CRDS gas analyzer can be avoided, and carbon isotopes can be accurately analyzed.

As a result of the above, the gas analysis system according to the present disclosure can accurately analyze carbon isotopes while suppressing the maintenance frequency of the reduction unit.

(Item 2) In the gas analysis system according to item 1, the first gas separation unit temporarily traps the first mixed gas, exhausts a remaining gas other than the first mixed gas to the outside while the first mixed gas is temporarily trapped, and supplies the first mixed gas to the reduction unit after exhausting the remaining gas other than the first mixed gas to the outside.

In the gas analysis system according to item 2, the first gas separation unit can remove oxygen from the sample gas by temporarily trapping carbon dioxide and nitrous oxide contained in the sample gas.

(Item 3) In the gas analysis system according to item 2, the first gas separation unit includes a column filled with an adsorbent that adsorbs carbon dioxide and nitrous oxide.

In the gas analysis system according to item 3, the first gas separation unit can remove oxygen from the sample gas by temporarily adsorbing carbon dioxide and nitrous oxide contained in the sample gas with an adsorbent in a column.

(Item 4) In the gas analysis system according to item 2, a sample and oxygen gas that functions as an auxiliary combustion gas and a carrier gas are supplied to the combustion device from the outside. The gas that the first gas separation unit exhausts to the outside includes nitrogen oxides other than nitrous oxide, sulfur oxides, and surplus oxygen gas that was not used for combustion in the combustion device.

In the gas analysis system according to item 4, since oxygen gas that functions not only as an auxiliary combustion gas but also as a carrier gas is supplied to the combustion device, a large amount of oxygen gas is introduced from the combustion device to the gas treatment device. However, the oxygen gas is removed by the first gas separation unit arranged upstream of the reduction unit. Therefore, the introduction of a large amount of oxygen gas into the reduction unit can be suppressed. This can suppress the maintenance frequency of the reduction unit.

(Item 5) In the gas analysis system according to item 4, a carrier gas different from the oxygen gas is supplied to the first gas separation unit from the outside.

In the gas analysis system according to item 5, even when oxygen gas that also functions as a carrier gas is removed by the first gas separation unit, the first mixed gas can be transported to the reduction unit by a carrier gas different from the oxygen gas.

(Item 6) In the gas analysis system according to item 1, the gas treatment device further includes a gas drying unit that is arranged between the combustion device and the CRDS gas analyzer and removes a water component in the sample gas generated in the combustion device.

In the gas analysis system according to item 6, the water component in the sample gas generated in the combustion device is removed by the gas drying unit. Therefore, the water component is prevented from being introduced into the CRDS gas analyzer. This can prevent a decrease in the accuracy of CRDS measurement due to the water component adhering to the high-reflectivity mirrors in the CRDS gas analyzer.

(Item 7) In the gas analysis system according to item 1, a combustion tube of an organic elemental analyzer using a gas chromatography column is used as the combustion device.

In the gas analysis system according to item 7, the mixed gas that is exhausted without being used for measurement in the organic elemental analyzer using a gas chromatography column can be effectively used as a sample gas for CRDS.

(Item 8) In the gas analysis system according to any one of items 1 to 7, the gas treatment device further includes a second gas separation unit that is arranged downstream of the reduction unit, separates the second mixed gas into carbon dioxide gas and a remaining gas other than carbon dioxide gas, and supplies the carbon dioxide gas to the CRDS gas analyzer.

In the gas analysis system according to item 8, the sample gas generated by combusting an organic sample in a combustion device passes through a first gas separation unit, a reduction unit, and a second gas separation unit in this order and is supplied to a CRDS gas analyzer.

In the second gas separation unit, a remaining gas other than carbon dioxide gas is removed from the second mixed gas introduced from the reduction unit, and the carbon dioxide gas is supplied to the CRDS gas analyzer. The second mixed gas introduced into the second gas separation unit is in a state of not containing nitrous oxide gas due to the reduction action of the reduction unit. Therefore, even if the second gas separation unit has a configuration that cannot separate carbon dioxide and nitrous oxide, nitrous oxide is not introduced into the CRDS gas analyzer, but carbon dioxide is introduced. As a result, interference between the spectral peaks of carbon dioxide and nitrous oxide in the CRDS gas analyzer can be avoided, and carbon isotopes can be accurately analyzed.

The embodiments disclosed this time should be considered to be illustrative in all respects and not restrictive. The scope of the present invention is indicated by the claims rather than by the description of the embodiments, and it is intended that all modifications within the meaning and scope equivalent to the claims are included.

### DESCRIPTION OF THE REFERENCE NUMERALS

1, 1A Gas analysis system, 10 Combustion device, 20 Gas treatment device, 21 Gas drying unit, 22 First gas separation unit, 23 Reduction unit, 24 Second gas separation unit, 30 CRDS gas analyzer.

1. A gas analysis system, comprising:
a combustion device configured to generate a sample gas by combusting a sample with oxygen introduced therein;
a gas treatment device configured to increase a partial pressure ratio of carbon dioxide in the sample gas; and
a CRDS gas analyzer configured to analyze the carbon dioxide gas that has passed through the gas treatment device using cavity ring-down spectroscopy,
wherein the gas treatment device includes:
a first gas separation unit configured to separate the sample gas into a first mixed gas of carbon dioxide and nitrous oxide and a remaining gas other than the first mixed gas and to allow the first mixed gas to pass therethrough; and
a reduction unit arranged downstream of the first gas separation unit and configured to reduce nitrous oxide in the first mixed gas to nitrogen gas and to allow a second mixed gas containing carbon dioxide and nitrogen to pass therethrough.

2. The gas analysis system according to claim 1, wherein the first gas separation unit is configured to: temporarily trap the first mixed gas; exhaust a remaining gas other than the first mixed gas to an outside while the first mixed gas is temporarily trapped; and supply the first mixed gas to the reduction unit after exhausting the remaining gas other than the first mixed gas to the outside.

3. The gas analysis system according to claim 2, wherein the first gas separation unit comprises a column filled with an adsorbent that adsorbs carbon dioxide and nitrous oxide.

4. The gas analysis system according to claim 2, wherein the sample and oxygen gas that functions as an auxiliary combustion gas and a carrier gas are supplied to the combustion device from an outside, and the gas that the first gas separation unit exhausts to the outside includes nitrogen oxides other than nitrous oxide, sulfur oxides, and surplus oxygen gas that was not used for combustion in the combustion device.

5. The gas analysis system according to claim 4, wherein a carrier gas different from the oxygen gas is supplied to the first gas separation unit from an outside.

6. The gas analysis system according to claim 1, wherein the gas treatment device further comprises a gas drying unit arranged between the combustion device and the CRDS gas analyzer and configured to remove a water component in the sample gas generated in the combustion device.

7. The gas analysis system according to claim 1, wherein a combustion tube of an organic elemental analyzer using a gas chromatography column is used as the combustion device.

8. The gas analysis system according to claim 1, wherein the gas treatment device further comprises a second gas separation unit arranged downstream of the reduction unit and configured to separate the second mixed gas into carbon dioxide gas and a remaining gas other than carbon dioxide gas and to supply the carbon dioxide gas to the CRDS gas analyzer.
